(19) United States
(12) Patent Application Publication
(10) Pub. No.: US 2009/0183356 A1
(43) Pub. Date: Jul. 23, 2009

(54) Method for assembling parts of cycle frame

(76) Inventor: Chang Hui Lin, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/009,922

(22) Filed: Jan. 23, 2008

(51) Int. Cl. B23P 11/02; B62K 3/02

(52) U.S. Cl. 29/509; 280/281.1

(57) ABSTRACT

A method is used for assembling a cycle frame which includes a number of male members each having one or more male fitting elements, and a number of female members each having one or more female fitting elements, the male members may be frozen in such as a liquid nigrogen to contract the male fitting element before the male fitting elements are engaged into the female fitting elements, or the female members may be heated in such as a high frequency furnace to expand the female fitting elements before the male fitting elements are engaged and assembled into the female fitting elements, for allowing the parts to be assembled together without latches, fasteners, adhesive materials or welding seams.

### BACKGROUND OF THE INVENTION

1. Field of the Invention

The present invention relates to a method for assembling the cycle frames, and more particularly to a method for assembling the parts of the cycle frames by heating or cooling some of the parts of the cycle frames, and then assembling the parts before the heated or the cooled parts are returned back to the normal or the room temperature and thus for allowing the parts to be assembled and secured together without latches, fasteners, adhesive materials or welding seams.

2. Description of the Prior Art

Typical bicycle frames comprise a number of parts including a steering tube, a front fork, an upper tube, a diagonal tube, a saddle tube, a rear fork, a saddle fitting, a crank-gear fitting, and a horizontal rear fork to be assembled and secured together.

For example, U.S. Pat. No. 3,860,265 to Weiss discloses one of the typical bicycle frames comprising a number of metal tube elements welded or brazed together.

However, the welding processes may pollute our environment, and the welding seams may greatly increase the weight of the typical bicycle frames.

U.S. Pat. No. 4,479,662 to Defour et al. discloses another typical bicycle frames comprising a number of male and female elements having tubular and hollow fittings for engaging with each other.

However, the assembled male and female elements are then required to be secured together with adhesive materials such that the manufacturing processes for the typical bicycle frames are complicated.

U.S. Pat. No. 4,550,927 to Resele discloses a further typical bicycle frame comprising two die-cast light metal semimonocoques adhesively joined at their adjoining edges, in which the edges are interengaged and the semimonocoques are additionally held together by rivets, screws and/or pins inserted into abutting bosses integrally formed on the insides of the semimonocoques.

However, similarly, the adhering processes for the typical bicycle frames are complicated, and the adhesive materials will be failed after being used for a predetermined time interval.

U.S. Pat. No. 4,856,800 to Hashimoto et al. discloses a still further typical bicycle frame comprising a number of parts, and a sheet molding compound covers the joining portions of the parts for solidly securing the joining portions of the parts together with a hot-compressing molding procedure.

However, the covering of the sheet molding compound onto the joining portions of the parts is complicated, and a large amount of the man power is required for securing the joining portions of the parts together with the sheet molding compound.

The present invention has arisen to mitigate and/or obviate the afore-described disadvantages of the conventional methods for assembling the parts of the cycle frames together.

### SUMMARY OF THE INVENTION

The primary objective of the present invention is to provide a method for assembling the parts of the cycle frames by heating or cooling some of the parts of the cycle frames, and then assembling the parts before the heated or the cooled parts are returned back to the normal or the room temperature and thus for allowing the parts to be assembled and secured together without latches, fasteners, adhesive materials or welding seams.

In accordance with one aspect of the invention, there is provided a method for assembling a cycle frame, the cycle frame comprising a number of male members including an upper tube, a down tube, a saddle tube, a seat stay, and a chain stay each having at least one male fitting element, and comprising a number of female members including a steering tube, a saddle fitting and a crank-gear fitting each having at least one female fitting element, the method comprising changing a temperature between the male fitting element and the female fitting element for allowing the male fitting element to be easily and quickly engaged and assembled into the female fitting element without latches, fasteners, adhesive materials or welding seams.

For example, the male members may be frozen to contract the male fitting element before the male fitting element is engaged and assembled into the female fitting element, and the male members may be frozen by immersing the male members in such as a liquid nigrogen or the like in order to contract the male fitting element of the male members.

The female members may also be heated to expand the female fitting element before the male fitting element is engaged and assembled into the female fitting element, and the female members may be heated in such as a high frequency furnace in order to expand the female fitting element of the female members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a method for assembling the male and female elements or parts of the cycle frames in accordance with the present invention;

FIG. 2 is a perspective view of the assembled cycle frame;

FIG. 3 is a side plan schematic view of the assembled cycle frame;

FIG. 4 is a block diagram illustrating the operation or the manufacturing processes for the cycle frame; and

FIG. 5 is a block diagram similar to FIG. 4 illustrating the other manufacturing processes for the cycle frame.

### DETAILED DESCRIPTION OF THE PREFERRED EMBODIMENT

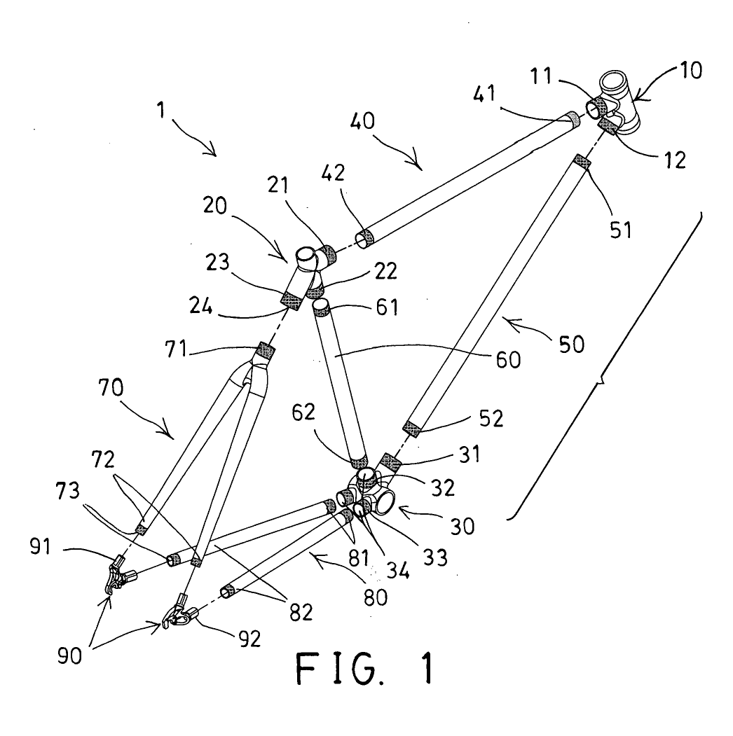

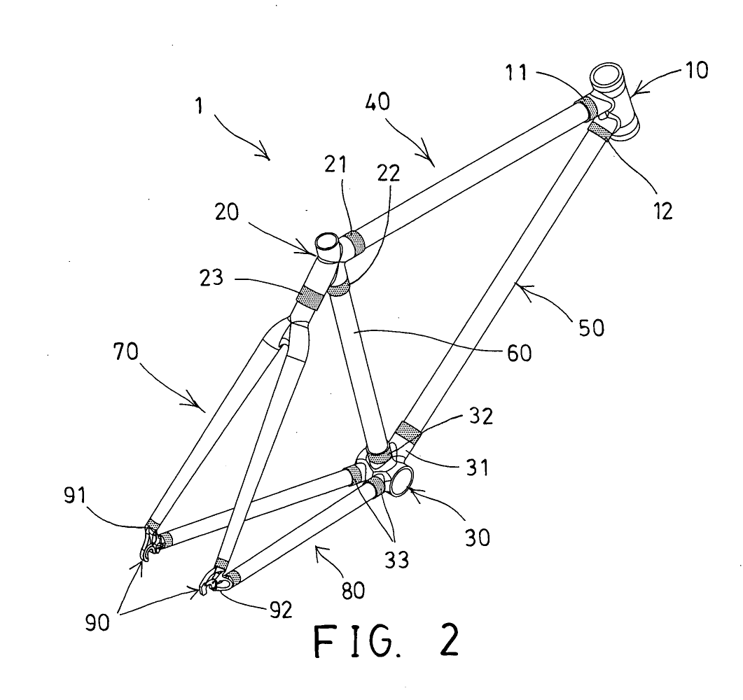

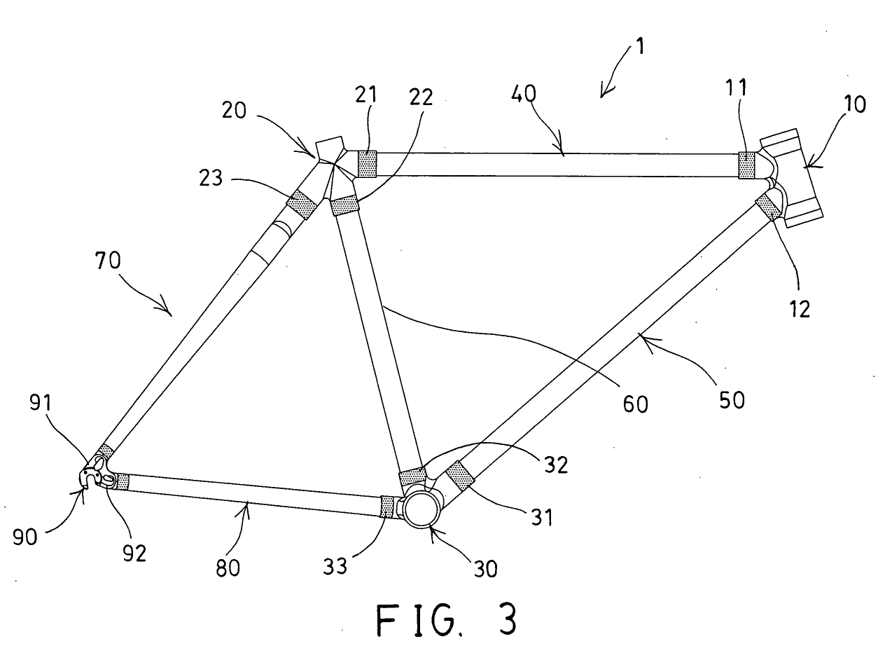

Referring to the drawings, and initially to FIGS. 1-3, a method in accordance with the present invention is provided for assembling the parts of a bicycle or cycle frame 1 without latches, fasteners, adhesive materials or welding seams, in which the cycle frame 1 comprises a steering tube 10 for rotatably attaching or supporting a front fork (not shown), a saddle fitting 20 for supporting a seat or saddle (not shown) thereon, a crank-gear fitting 30 for supporting a crank device (not shown), an upper tube 40, a diagonal or down tube 50, a seat or saddle tube 60, a bracing rear fork or seat stay 70, a horizontal rear fork or chain stay 80, and one or more rear axle drop-out members 90 to be assembled and secured together by heating or cooling processes.

The female members 10-30, such as the steering tube 10 and the saddle fitting 20 and the crank-gear fitting 30 each include one or more barrels or adapters or female fitting elements 11, 12; 21, 22, 23; 31, 32, 33 extended outwardly therefrom and each having a bore 14, 24, 34 formed therein for forming or acting as a female fitting element and for receiving or for engaging with the end portions or the male fitting elements 41, 42; 51, 52; 61, 62; 71, 72; 81, 82 of the male members 40-80 respectively, in which the male members 40-80 include the upper tube 40, the down tube 50, the saddle tube 60, the seat stay 70, and the chain stay 80. The steering tube 10, the saddle fitting 20, the crank-gear fitting 30, the upper tube 40, the down tube 50, the saddle tube 60, the seat stay 70, the chain stay 80, and the rear axle drop-out members 90 are made of aluminum or metal materials that may be enlarged or expanded by heating and that may be reduced or shrunk or contracted by a cold temperature or freezing.

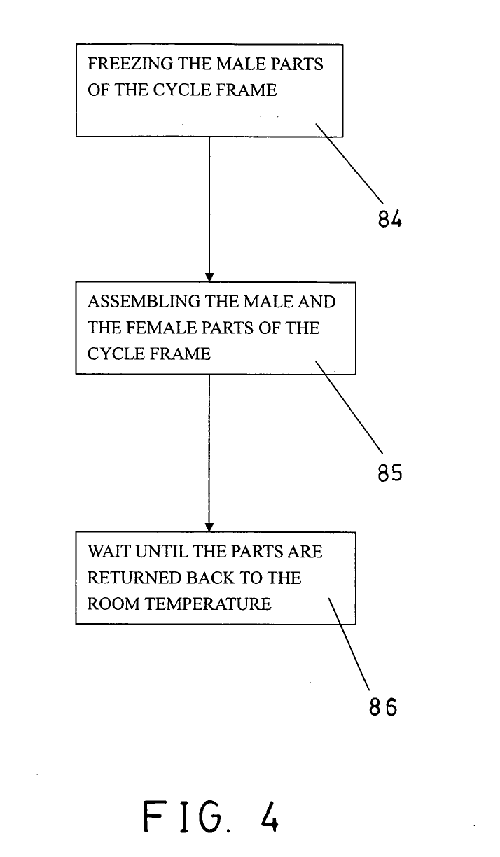

In assembling the parts 10-90 of the cycle frame 1, as shown in FIG. 4, the male fitting elements 41, 42; 51, 52; 61, 62; 71, 72; 81, 82 of the male members 40-80 may be cooled or frozen in the process 84 to a temperature below zero, by such as immersing the male members 40-80 in the liquid nigrogen, for shrinking or contracting the male members 40-80, particularly the end male fitting elements 41, 42; 51, 52; 61, 62; 71, 72; 81, 82 of the male members 40-80 for allowing the shrunk or contracted male fitting elements 41, 42; 51, 52; 61, 62; 71, 72; 81, 82 of the male members 40-80 to be easily and quickly engaged or assembled into the bores 14, 24, 34 of the female fitting elements 11, 12; 21, 22, 23; 31, 32, 33 of the female members 10-30 in the process 85 and to be solidly secured to the female members 10-30 after the frozen male members 40-80 are expanded or returned back to the normal or the room temperature in the process 86.

Similarly, the male fitting elements 91, 92 of the rear axle drop-out members 90 may be cooled or frozen in the process 84 to the temperature below zero, by such as immersing the male members 90 in the liquid nigrogen, for shrinking or contracting the male members 90 for allowing the shrunk or contracted male fitting elements 91, 92 of the male members 90 to be easily and quickly engaged or assembled into the bores 73 of the female fitting elements 72, 82 of the female members 70, 80 in the process 85 and to be solidly secured to the female members 70, 80 after the frozen male members 90 are returned back to the normal or the room temperature in the process 86.

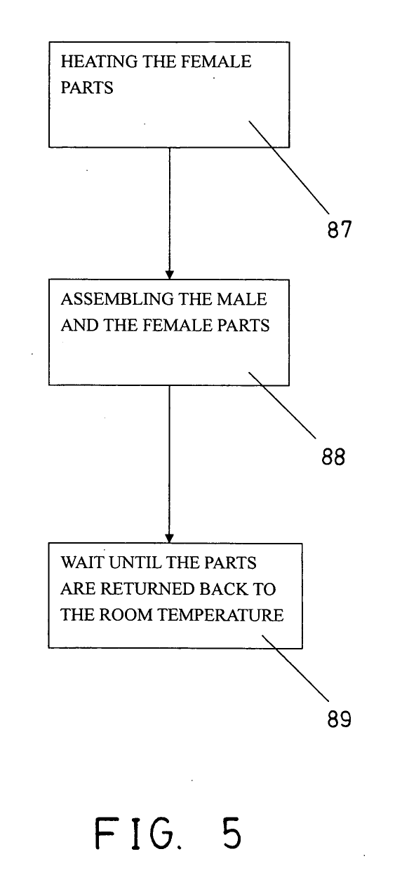

Alternatively, as shown in FIG. 5, the female members 10-30 may be heated in the process 87 to the greater or hotter temperature with such as a high frequency furnace (not-shown) in order to expand the female fitting elements 11, 12; 21, 22, 23; 31, 32, 33 of the female members 10-30, and for allowing the male fitting elements 41, 42; 51, 52; 61, 62; 71, 72; 81, 82 of the male members 40-80 to be easily and quickly engaged or assembled into the bores 14, 24, 34 of the heated female fitting elements 11, 12; 21, 22, 23; 31, 32, 33 of the female members 10-30 in the process 88 and to be solidly secured to the female members 10-30 after the heated female members 10-30 are returned back to the normal or the room temperature in the process 89.

Similarly, the female fitting elements 72, 82 of the female members 70, 80 may also be heated in the process 87 to the greater or hotter temperature with such as a high frequency furnace (not shown) in order to expand the female fitting elements 72, 82 of the female members 70, 80, and for allowing the male fitting elements 91, 92 of the rear axle drop-out members or male members 90 to be easily and quickly engaged or assembled into the bores 73 of the heated female fitting elements 72, 82 of the female members 70, 80 in the process 88 and to be solidly secured to the female members 70, 80 after the heated female members 70, 80 are shrunk or contracted or returned back to the normal or the room temperature in the process 89, such that the parts 10-90 of the cycle frame 1 may be easily and quickly assembled together by changing the temperature between the female members 10-30; or 70, 80 and the male members 40-80; or 90 without latches, fasteners, adhesive materials or welding seams.

Alternatively, the end portions or the fitting elements 41, 42; 51, 52; 61, 62; 71, 72; 81, 82 of the members 40-80 may also be formed or acted as the female fitting elements of the female members for receiving or engaging with the end portions or male fitting elements 11, 12; 21, 22, 23; 31, 32, 33 of the male members 10-30.

Accordingly, the method in accordance with the present invention may be provided for assembling the parts of the cycle frames by heating or cooling some of the parts of the cycle frames, and then assembling the parts before the heated or the cooled parts are returned back to the normal or the room temperature and thus for allowing the parts to be assembled and secured together without latches, fasteners, adhesive materials or welding seams.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for assembling a cycle frame, the cycle frame including a plurality of male members each having at least one male fitting element, and including a plurality of female members each having at least one female fitting element, said method comprising:
changing a temperature between said at least one male fitting element and said at least one female fitting element for allowing said at least one male fitting element to be engaged and assembled into said at least one female fitting element.

2. The method as claimed in claim 1, wherein said male members are frozen to contract said at least one male fitting element before said at least one male fitting element is engaged and assembled into said at least one female fitting element.

3. The method as claimed in claim 2, wherein said male members are frozen by immersing said male members in a liquid nigrogen.

4. The method as claimed in claim 1, wherein said female members are heated to expand said at least one female fitting element before said at least one male fitting element is engaged and assembled into said at least one female fitting element.

5. The method as claimed in claim 4, wherein said female members are heated in a high frequency furnace.

6. The method as claimed in claim 1, wherein said male members are selected from an upper tube, a down tube, a saddle tube, a seat stay, and a chain stay, and said female members are selected from a steering tube, a saddle fitting and a crank-gear fitting.

7. The method as claimed in claim 1, wherein said male members are selected from a rear axle drop-out member, and said female members are selected from a seat stay and a chain stay.

8. A method for assembling a cycle frame, the cycle frame comprising a plurality of male members including an upper tube, a down tube, a saddle tube, a seat stay, and a chain stay each having at least one male fitting element, and comprising a plurality of female members including a steering tube, a saddle fitting and a crank-gear fitting each having at least one female fitting element, said method comprising:
freezing said male members to contract said at least one male fitting element before said at least one male fitting element is engaged and assembled into said at least one female fitting element.

9. A method for assembling a cycle frame, the cycle frame comprising a plurality of male members including an upper tube, a down tube, a saddle tube, a seat stay, and a chain stay each having at least one male fitting element, and comprising a plurality of female members including a steering tube, a saddle fitting and a crank-gear fitting each having at least one female fitting element, said method comprising:
heating said female members to expand said at least one female fitting element before said at least one male fitting element is engaged and assembled into said at least one female fitting element.
